(19) United States
(12) Patent Application Publication
(10) Pub. No.: US 2018/0170127 A1
(43) Pub. Date: Jun. 21, 2018

(54) Wireless Determination of Alignment

(71) Applicant: Motorola Mobility LLC, Chicago, IL (US)

(72) Inventor: Scott DeBates, Chicago, IL (US)

(73) Assignee: Motorola Mobility LLC, Chicago, IL (US)

(21) Appl. No.: 15/383,493

(22) Filed: Dec. 19, 2016

(51) Int. Cl. B60C 23/04; B60C 11/24

(52) U.S. Cl. CPC B60C 23/0433; B60C 2019/004; B60C 11/243

(57) ABSTRACT

Systems and methods for monitoring tire state or condition use a RFID low power tags embedded in a vehicle tire in conjunction with an RFID reader to determine whether the tire needs alignment, e.g., is misaligned, and whether the tire is over or under inflated. Both objectives may be accomplished by detecting the location of a tag in each tire, the tag spanning substantially the width of the tire. One or more additional tags may be located along the circumference of the tire as well to aid in determining inflation.

### TECHNICAL FIELD

The present disclosure is related generally to wireless communication and detection technologies, and, more particularly, to a system and method for wirelessly determining alignment of an item.

### BACKGROUND

Vehicle fuel economy is an increasingly important priority for both citizens and governments. Not only is there widespread concern regarding fuel availability, but there is also concern that vehicle-based pollution may be contributing to environment problems. With this in mind, it is worthwhile noting that one of the biggest contributors to poor fuel economy, and to prematurely worn tires, is improper wheel alignment or improperly inflated tires. Current methods to determine alignment require vehicles to be placed on racks that measure the alignment. With respect to proper inflation, newer cars are equipped with tire pressure monitors (TPMs) to measure the pressure in each tire. However, these systems are costly and generally only determine pressure.

Before proceeding, it should be appreciated that the present disclosure is directed to a system that can eliminate some of the shortcomings noted in this Background section. However, any such benefit is not a limitation on the scope of the disclosed principles, or of the attached claims, except to the extent expressly noted in the claims. Additionally, the discussion of technology in this Background section is reflective of the inventors' own observations, considerations, and thoughts, and is in no way intended to accurately catalog or comprehensively summarize any prior art reference or practice. As such, the inventors expressly disclaim this section as admitted or assumed prior art. Moreover, the identification herein of desirable courses of action reflects the inventors' own observations and ideas, and should not be assumed to indicate an art-recognized desirability.

### SUMMARY

In an embodiment of the disclosed principles, through the use of an embedded RFID low power accelerometer tags the width of a car tire, an RFID reader can determine whether a vehicle tire needs alignment, e.g., is misaligned, and whether the tire is over or under inflated. Both objectives may be accomplished by detecting the location of the accelerometer tags in each tire. RFID sensor tags may span substantially the width of the tire, and one or more RFID sensor tags may additionally be located along the circumference of the tire as well to aid in determining inflation. An RFID reader may be configured to read the embedded RFID tags and provide feedback to the operator if alignment or inflation is incorrect.

In another aspect of the disclosed principles, a method of monitoring a vehicle tire includes emitting a near field radio frequency transmission receivable by one or more antennas embedded in the vehicle tire (the antenna being associated with radio frequency transmission circuitry), receiving one or more responsive radio frequency transmissions from respective ones of the one or more antennas embedded in the vehicle tire, determining based on the received one or more responsive radio frequency transmissions whether the vehicle tire is in an undesirable state, and alerting a vehicle user if the vehicle tire is determined to be in an undesirable state.

In another aspect of the disclosed principles, a system for monitoring a vehicle tire includes an antenna system embedded in the vehicle tire, the antenna system being configured to emit a responsive radio frequency (RF) signal when probed by an RF probe signal. An included monitoring device comprises an RF transceiver and a processor, the processor being configured to emit an RF probe signal receivable by the antenna system, characterize a responsive RF signal received from the antenna system and identify the vehicle tire as being in an undesired state based on the characterization of the responsive RF signal.

In yet another aspect of the disclosed principles, a device is provided for monitoring a condition of a vehicle tire having embedded therein at least one RFID antenna. The device includes a radio frequency (RF) transceiver, an RF antenna linked to the RF transceiver, and processor. The processor is configured to emit an RF probe signal from the RF antenna via the RF transceiver, the RF probe signal being receivable by the embedded RFID antenna, to receive a responsive RF signal from the at least one embedded RFID antenna, to characterize the responsive RF signal and to determine whether the vehicle tire is misaligned or improperly inflated based on the responsive RF signal.

Other features and aspects of the disclosed principles will be apparent from the detailed description taken in conjunction with the included figures, of which:

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified schematic of an example device with respect to which embodiments of the presently disclosed principles may be implemented;

FIG. 2 is a device-level schematic showing an operating environment in accordance with an embodiment of the disclosed principles;

FIG. 3 is a device-level schematic showing an alternative operating environment in accordance with an embodiment of the disclosed principles;

FIG. 4 is a flowchart of a process for gathering and interpreting RFID data in the context of monitoring a vehicle tire in accordance with an embodiment of the disclosed principles;

FIG. 5 is circuit diagram of an RFID tag antenna architecture usable in accordance with embodiments of the disclosed principles; and

FIG. 6 is a schematic side view of a tire having pressure and alignment RFID tags in keeping with an embodiment of the disclosed principles.

### DETAILED DESCRIPTION

Before presenting a detailed discussion of embodiments of the disclosed principles, an overview of certain embodiments is given to aid the reader in understanding the later discussion. As noted above, @@@@.

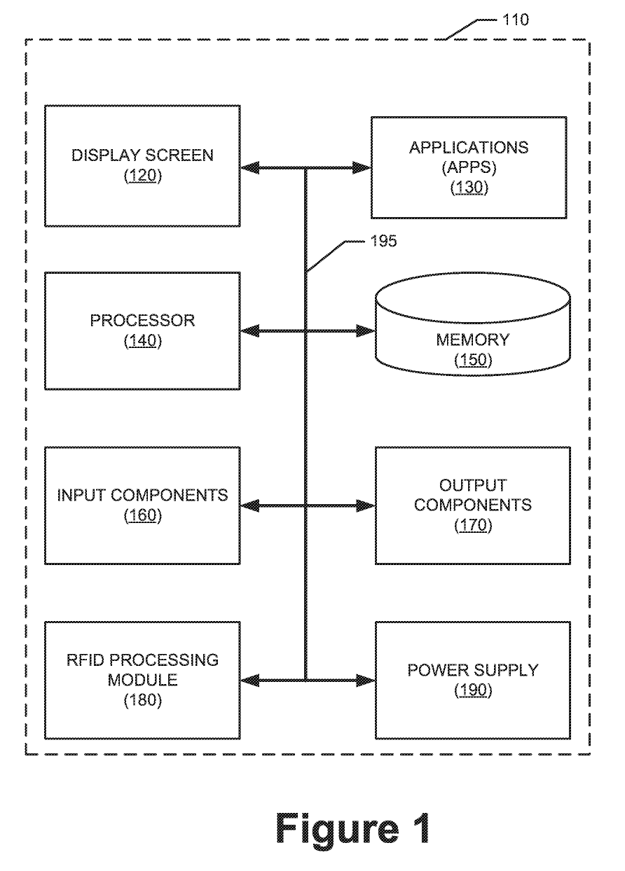

With this overview in mind, and turning now to a more detailed discussion in conjunction with the attached figures, the techniques of the present disclosure are illustrated as being implemented in a suitable computing environment. The following generalized device description is based on embodiments and examples within which the disclosed principles may be implemented, and should not be taken as limiting the claims with regard to alternative embodiments that are not explicitly described herein. Thus, for example, while FIG. 1 illustrates an example mobile device with which embodiments of the disclosed principles may be implemented, it will be appreciated that other device types may be used, including but not limited to laptop computers, tablet computers, embedded automobile computing systems and so on.

The schematic diagram of FIG. 1 shows an exemplary device 110 forming part of an environment within which aspects of the present disclosure may be implemented. In particular, the schematic diagram illustrates a user device 110 including several exemplary components. It will be appreciated that additional or alternative components may be used in a given implementation depending upon user preference, component availability, price point and other considerations.

In the illustrated embodiment, the components of the user device 110 include a display screen 120, applications (e.g., programs) 130, a processor 140, a memory 150, one or more input components 160 such as RF input facilities, and one or more output components 170 such as RF output facilities. It will be appreciated that a single transceiver and antenna may serve as both the output antenna and the receiving antenna. In addition, a gyroscope may also be included as one of the input components 160 as well.

The processor 140 can be any of a microprocessor, microcomputer, application-specific integrated circuit, or the like. For example, the processor 140 can be implemented by one or more microprocessors or controllers from any desired family or manufacturer. Similarly, the memory 150 may reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device or system). Additionally or alternatively, the memory 150 may include a read only memory (i.e., a hard drive, flash memory or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device 110. Such functions may include, for example, interaction among various internal components and storage and retrieval of applications and data to and from the memory 150.

Further with respect to the applications, these typically utilize the operating system to provide more specific functionality, such as file system service and handling of protected and unprotected data stored in the memory 150. Although many applications may provide standard or required functionality of the user device 110, in other cases applications provide optional or specialized functionality, and may be supplied by third party vendors or the device manufacturer.

With respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

The device 110 also includes an RFID processing module 180 to control the sending and receipt of RFID signals for example, and to process the results. In an embodiment, a power supply 190, such as a battery or fuel cell, is included for providing power to the device 110 and its components. All or some of the internal components communicate with one another by way of one or more shared or dedicated internal communication links 195, such as an internal bus.

In an embodiment, the device 110 is programmed such that the processor 140 and memory 150 interact with the other components of the device 110 to perform a variety of functions. The processor 140 may include or implement various modules (e.g., the RFID processing module 180) and execute programs for initiating different activities such as launching an application, transferring data and toggling through various graphical user interface objects (e.g., toggling through various display icons that are linked to executable applications).

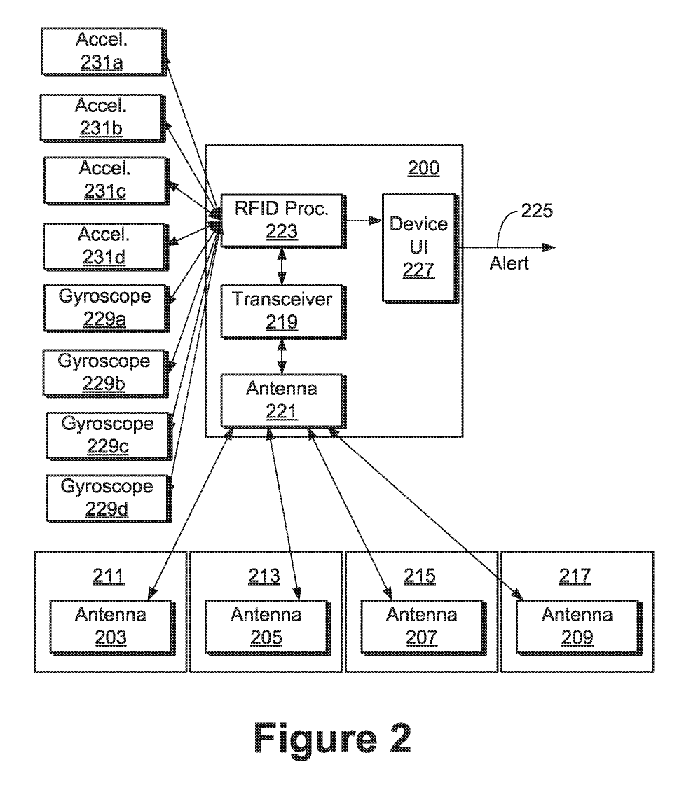

Turning to FIG. 2, this figure provides a device-level schematic showing an operating environment in accordance with an embodiment of the disclosed principles. As can be seen, a monitoring device 201, e.g., a device such as the device 110 shown in FIG. 1, is wirelessly associated with a plurality of embedded RFID antennas 203, 205, 207, 209. Each of the embedded RFID antennas 203, 205, 207, 209 is associated with a vehicle tire 211, 213, 215, 217. In an addition, a respective gyroscope 229a-229d may be included for each wheel to allow better tracking of changes in wheel orientation.

In operation, a transceiver 219 of the monitoring device 201, using an antenna 221, transmits a periodic EMF pulse, coded or otherwise, of sufficient strength to activate the embedded RFID antennas 203, 205, 207, 209. These embedded RFID antennas 203, 205, 207, 209 in turn emit a characteristic EMF transmission of sufficient strength to be received by the antenna 221 and interpreted by a transceiver 219.

In accordance with an aspect of the disclosed principles, the embedded RFID antennas 203, 205, 207, 209 are located within their respective tires 211, 213, 215, 217 in a manner such that the returned signal for the associated embedded RFID antenna 203, 205, 207, 209 of each tire 211, 213, 215, 217 can be used to identify the track and location of a portion of the tire. For example, as discussed above, a first set of RFID tags referred to as the accelerometer tags may span substantially the width of the tire and be positioned across the tire axially (from inside to outside) to aid in determining tracking, while an addition set of RFID tags may be positioned circumferentially in each tire to aid in determining inflation.

During operation, as the associated vehicle travels, the return signals from the accelerometer RFID tags will be processed to determine the location of orientation of the tag, and its relative orientation will be compared to the tag of the tire on the opposite side of the vehicle. For example, in an embodiment, if one tag is turned 5° left then the other should be turned 5° left as well. The data from the respective gyroscopes 229a-229d of the wheels associated with the tires 211, 213, 215, 217 may serve to check and refine the calculated track and orientation.

In an embodiment, the system accounts for desired toe-in of the tires. For example, it may be desired that the tires toe inward by a small number of degrees for stability, such that the alignment comparison looks for a specific variance rather than simply looking for 0° difference from left to right.

Moreover, the return signals from the circumferential tags are used in an embodiment to determine the circumference, and thus internal pressure, of each tire. The circumference may be determined from the return RF signals by determining the radial location of a circumferential tag, the size of a gap between the ends of the tag, and so on.

An RFID processing module 223 of the monitoring device 201 is configured to interpret the received RF data, e.g., to perform the above-referenced comparisons, to determine the inflation level and alignment of each tire or of a subset of the tires. For example, the RFID processing module 223 may calculate the alignment of only the vehicle's front tires while calculating the inflation state of all tires. The RFID processing module 223 may cause a corresponding alert 225 to be displayed or emitted to a user by the user interface (UI) 227 of the monitoring device 201. For example, the RFID processing module 223 may generate a user alert when a predetermined lower pressure limit is passed in one or more tires, when the pressure variance between tires exceeds a predetermined pressure variance limit, or when two or more tires are misaligned from a predetermined angle by more than an allowed variance limit.

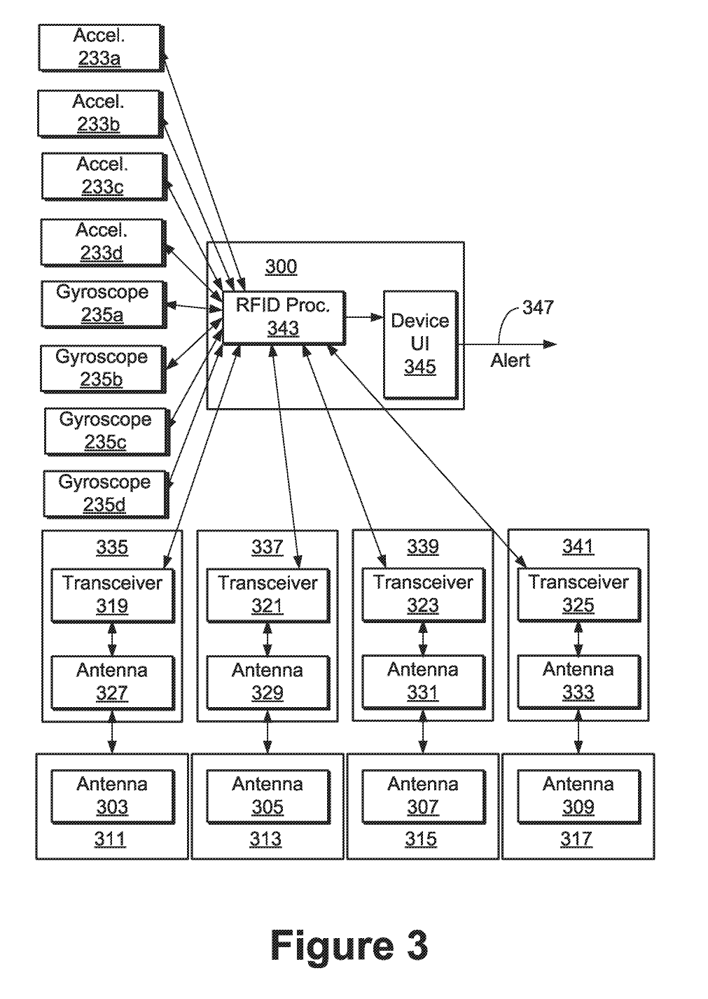

In an alternative embodiment consistent with the disclosed principles, the monitoring of the embedded antennas may instead be distributed as shown in FIG. 3. This embodiment may be beneficial in contexts wherein the tires to be monitored are too far apart to enable RFID communications of all antennas with a single central device.

In this alternative embodiment, each tire 311, 313, 315, 317 includes one or more respective embedded RFID antennas 303, 305, 307, 309 as in the prior embodiment. However, the system now includes a separate radio unit 335, 337, 339, 341 for each embedded RFID antenna 303, 305, 307, 309. Typically, each radio unit 335, 337, 339, 341 will be located within short-range communication distance (e.g., within one or two feet) of the associated tire 311, 313, 315, 317 and its respective embedded RFID antenna 303, 305, 307, 309. As with the prior embodiment, respective gyroscopes 235a-235d of the wheels associated with the tires 335, 337, 339, 341 may be used to further generate or to further refine calculated tracking and orientation data.

A central device 300, which may be a mobile telecommunications device such as device 110 or otherwise, e.g., a CAN (Car Area Network) controller or the like, receives data from the separate radio unit 335, 337, 339, 341 at its RFID processor 343 and interprets the data as above to determine alignment and pressure of the associated tire 311, 313, 315, 317. The central device 300 also receives data from the gyroscopes 235a-235d Subsequently, the RFID processor 343 may display or emit an alert via the user interface (UI) 345 of the monitoring device 300. The alert criteria may be the same as or different from those discussed above with respect to FIG. 2.

More generally, in various embodiments of the disclosed principles within this context, a system's RFID processing module may interpret the existence, movement or repetition frequency of the responsive RFID signal from the embedded antenna to indicate one or more conditions with respect to the associated tire. For example, nonexistence of a responsive RFID signal may indicate antenna failure, and therefore tire wear or failure; similarly, the repetition frequency of the responsive RFID signal may be used to infer an RPM of the associated tire.

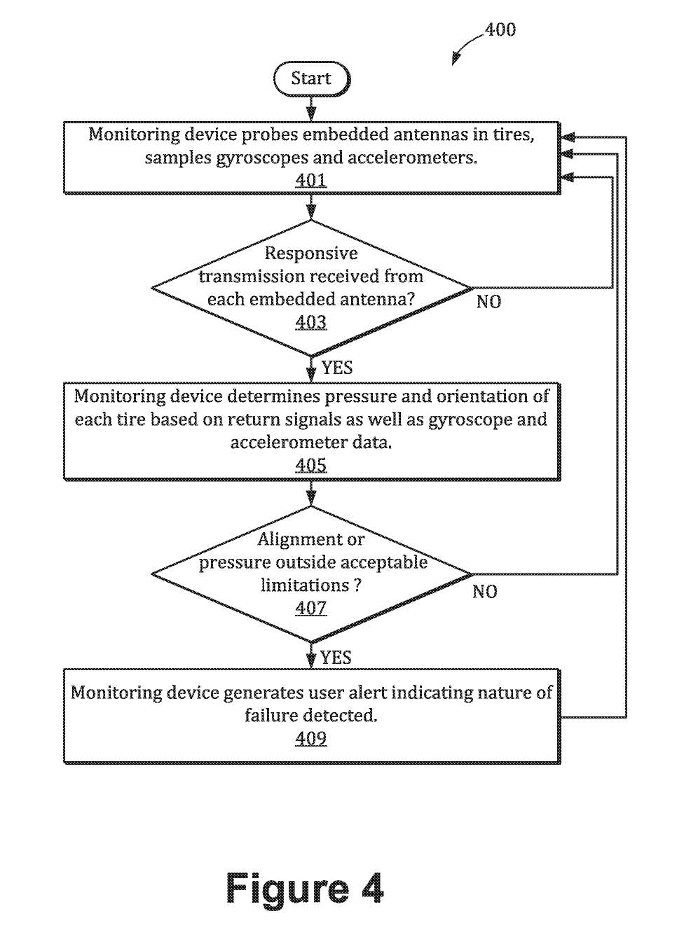

FIG. 4 is a flowchart of a process 400 for gathering and interpreting RFID data in the context of monitoring a tire for alignment and pressure. The system architecture in this example may be either of those shown in FIGS. 2 and 3, or otherwise.

At stage 401 of the process 400, the monitoring device causes a ping or query to be transmitted to a plurality of embedded antennas in a corresponding plurality of tires that are mounted and in use, and samples one or gyroscopes associated with each wheel. At stage 403 of the process 400, the monitoring device determines whether a responsive transmission has been received from each embedded antenna. In order for the monitoring device to determine if a response has been received from each embedded antenna, it is helpful to be able to distinguish between responses received from different antennas, especially if centralized detection is employed. In this regard, the embedded antenna responses may be distinguished by any relevant characteristic, e.g., ID encoding, signal attenuation, differential TOF (time-of-flight) and so on.

If it is determined that responses have not been received from all embedded antennas then the process 400 returns to stage 401. If it is determined that responses have been received from all embedded antennas, then the process 400 continues to stage 405, wherein the monitoring device determines the inflation pressure and relative orientation of each pair of tires based on the received responsive transmissions and the gyroscope data.

At stage 407, the monitoring device determines whether the tire alignment or pressure values fall outside of acceptable limitations. For example, as noted above, the a tire pressure that falls below a predetermined lower pressure limit or that varies from another tire by more than a predetermined pressure variance limit may cause a determination that tire pressures fall outside of acceptable limitations. Similarly, when the detected tire orientations indicate that two or more tires are misaligned from a predetermined angle by more than an allowed variance limit, this may cause a determination that tire alignment fall outside of acceptable limitations.

If it is determined at stage 407 that the tire alignment or pressure values fall within acceptable limitations, then the process 400 returns to stage 401, wherein the monitoring device again checks the embedded tags. If instead it is determined at stage 407 that the tire alignment or pressure values fall outside of acceptable limitations, then the process 400 flows to stage 409, wherein the monitoring device generates a user alert indicating the particular failure detected.

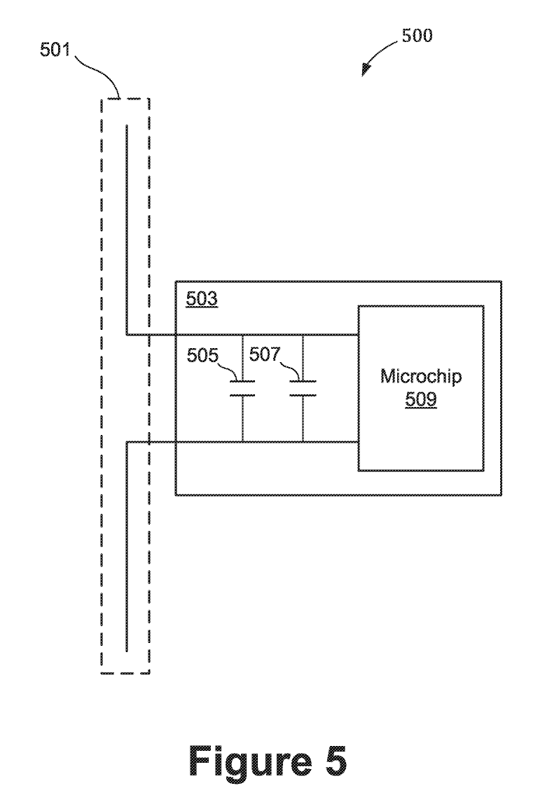

Although there are numerous different RFID antenna architectures in use, an example of one such configuration is shown in FIG. 5 for the sake of completeness. In particular, FIG. 5 is circuit diagram of a passive RFID tag antenna architecture usable in accordance with an embodiment of the disclosed principles. As can be seen, the circuit 500 includes an antenna 501 as well as a response portion 503. The response portion 503 of the circuit 500 contains one or more filtering capacitors 505, 507 as well as a microchip 509.

In operation, the receipt of an EMF signal at the antenna 501 induces a voltage in the response circuit 503. The voltage in the response circuit 503 is filtered by the one or more filtering capacitors 505, 507 before being provided to the microchip 509. The microchip 509, having been energized, emits a characteristic response for transmission by the antenna 501. In this way, the receipt of an EMF signal at the passive RFID tag causes the re-radiation of a signal that is characteristic of the particular passive RFID tag.

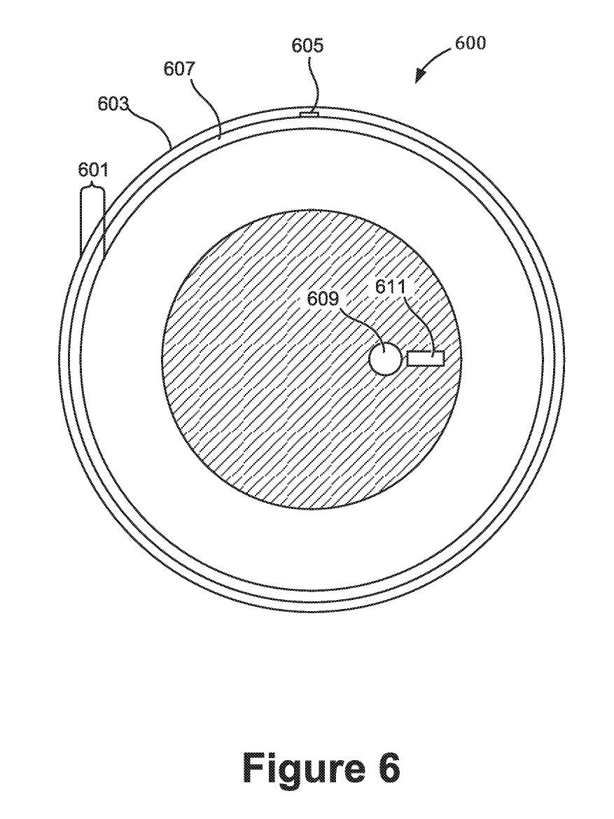

FIG. 6 is a sectional side view of a tire having pressure and alignment RFID tags in keeping with an embodiment of the disclosed principles. The illustrated tire 600 has a circumferential outer surface 601 bearing tire tread 603. Embedded within or beneath the tire tread 603 are one or more RFID tags comprising an alignment tag having an alignment antenna 605 and a pressure tag having a pressure antenna 607. In the illustrated embodiment, the alignment antenna 605 spans the width of the trade surface and as such is directed perpendicular to the plane of the page. The pressure antenna 607 wraps around the circumference of the tire 600 in the illustrated embodiment.

Thus, as the tire rotates, an adjacent RFID reader is able to track each antenna to provide pressure and alignment information. In an embodiment, however, a single circumferential tag is employed to provide both sets of data. In addition, in an embodiment wherein either tag is within the tread surface at a suitable depth, the ability or inability to receive a responsive signal from the antenna allows the RFID reader to determine whether the antenna is damages and thus to determine the level of tire wear.

It will be appreciated that various systems and processes for RFID-enabled tire pressure and alignment detection have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

1. A method of monitoring a vehicle tire comprising:
emitting a near field radio frequency transmission receivable by two or more antennas embedded in a first vehicle tire and a second vehicle tire respectively, each such antenna being associated with respective radio frequency transmission circuitry;
receiving one or more responsive radio frequency transmissions from respective ones of the two or more antennas;
determining a steering angle of each tire based on the responsive radio frequency transmissions;
determining based on the determined steering angles whether the first and second vehicle tires are misaligned with one another; and
alerting a vehicle user if it is determined that the first and second vehicle tires are misaligned with one another.

2. The method in accordance with claim 1, further comprising determining based on the responsive radio frequency transmissions that one of the antennas is damaged and in response alerting the vehicle user that one tire has experienced excess tread wear.

3-6. (canceled)

7. The method in accordance with claim 1 further comprising determining based on the responsive radio frequency transmissions that at least one tire is in a state of improper inflation.

8. The method in accordance with claim 7 wherein at least one of the one or more antennas is arranged circumferentially in its associated tire, and wherein determining that at least one tire is in a state of improper inflation comprises determining, based on the received one or more responsive radio frequency transmissions, that the tire circumference reflects a state of improper inflation.

9. The method in accordance with claim 1 further comprising receiving one or more gyroscope signals from the wheel of each tire and wherein determining whether the first and second vehicle tires are misaligned with one another further comprises determining a wheel orientation for each wheel based at least in part on the one or more gyroscope signals.

10. A system for monitoring a vehicle tire, the system comprising:
an antenna system embedded in each of two vehicle tires, the antenna system being configured to emit a responsive radio frequency (RF) signal when probed by an RF probe signal; and
a monitoring device comprising an RF transceiver and a processor, the processor being configured to emit an RF probe signal receivable by the antenna systems, characterize responsive RF signals received from the antenna systems and identify an angle between the vehicle tires based on the characterization of the responsive RF signals.

11. The system in accordance with claim 10 wherein the processor is further configured to notify a user that the vehicle tires are misaligned based on the identified angle.

12. The system in accordance with claim 10 wherein the processor is further configured to determine that one of the tires exhibits excess tread wear based on a characteristic of the responsive RF signal received from the antenna system in the tire.

13. The system in accordance with claim 12 wherein the processor is further configured to determine that the one of the tires exhibits excess tread wear by determining that a radio frequency signal has not been received from the antenna.

14-16. (canceled)

17. The system in accordance with claim 10 wherein the processor is further configured to determine that one of the tires is improperly inflated based on the characterization of the responsive RF signals.

18. The system in accordance with claim 17 wherein at least one of the one or more antennas is arranged circumferentially in the tire.

19. A device for monitoring a condition of a vehicle tire having embedded therein at least one RFID antenna, the device comprising:
a radio frequency (RF) transceiver;
an RF antenna linked to the RF transceiver; and
a processor configured to emit an RF probe signal from the RF antenna via the RF transceiver, the RF probe signal being receivable by the embedded RFID antenna, to receive a responsive RF signal from the at least one embedded RFID antenna, to characterize the responsive RF signal and to determine an orientation of the vehicle tire based on the responsive RF signal.

20. The device in accordance with claim 19, wherein the at least one RFID antenna includes a first antenna embedded across the tire tread and a second antenna embedded around the tire circumference.
